(19) United States
(12) Patent Application Publication
(10) Pub. No.: US 2014/0111055 A1
(43) Pub. Date: Apr. 24, 2014

(54) CONDUCTOR WITH DIVOT FOR IMPROVED FORM FACTOR

(71) Applicant: REMY TECHNOLOGIES L.L.C., Pendleton, IN (US)

(72) Inventor: Bradley D. Chamberlin, Pendleton, IN (US)

(73) Assignee: REMY TECHNOLOGIES, L.L.C., Pendleton, IN (US)

(21) Appl. No.: 13/658,371

(22) Filed: Oct. 23, 2012

(51) Int. Cl. H02K 3/12; B21D 31/00; H01B 7/00

(52) U.S. Cl. 310/208; 174/110 R; 72/46

(57) ABSTRACT

A conductive element is provided and includes an electrically conductive material and a coating surrounding the electrically conductive material to form a coated member. The coated member is formed with a crown defined by bends in first and second transverse dimensions. The electrically conductive material is formed to define at least one divot proximate to the crown. The at least one divot is discernible through the coating.

### BACKGROUND OF THE INVENTION

The subject matter disclosed herein relates to a conductor with a divot for an improved form factor and to an electro-dynamic machine including a conductor with a divot for an improved form factor.

Electro-dynamic machines generally operate by using electricity to generate mechanical energy. The electricity is supplied to conductive elements that are supported on a stator assembly to surround a rotor having magnetic elements. The flow of current through the conductive elements generates a magnetic flux that is applied to the magnetic elements on the rotor, which causes the rotor to rotate.

The conductive elements are often wired to extend in and out of the stator assembly and thus form end turns at axial ends of the stator assembly. It is typically desirable for the end turn height (relative to a plane of a corresponding axial end of the stator assembly) to be limited to a predefined height but clearances between adjacent conductive elements are generally required as well to avoid or mitigate a risk of a short circuit.

### BRIEF DESCRIPTION OF THE INVENTION

According to one aspect of the invention, a conductive element is provided and includes an electrically conductive material and a coating surrounding the electrically conductive material to form a coated member. The electrically conductive material is formed to define at least one divot proximate to the crown. The at least one divot is discernible through the coating.

According to another aspect of the invention, an electro-dynamic machine is provided and includes a stator, a rotor rotatably disposed in the stator and a plurality of conductive elements supportively disposed in the stator and receptive of current to drive rotation of the rotor. Each one of the plurality of conductive elements includes an electrically conductive material and a coating surrounding the electrically conductive material and is formed with a crown defined by bends in first and second transverse dimensions. The electrically conductive material is formed to define at least one divot proximate to the crown. The at least one divot is discernible through the coating.

According to yet another aspect of the invention, a method of fashioning a conductive element is provided and includes surrounding an electrically conductive material with a coating to form a coated member, bending the coated member in first and second transverse dimensions to provide the coated member with a crown and defining at least one divot in the electrically conductive material proximate to the crown during the bending such that the at least one divot is discernible through the coating.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic side view of an electro-dynamic machine;

FIG. 2 is a perspective view of a stator of the electro-dynamic machine of FIG. 1;

FIG. 3 is a side view of a conductive element of the stator of FIG. 2;

FIG. 4 is an axial view of a cross-section of the conductive element of FIG. 3;

FIG. 5 is a perspective view of a portion of the electro-dynamic machine in accordance with embodiments; and

FIG. 6 is a perspective view of a portion of an electro-dynamic machine lacking conductive elements with divots.

The detailed description explains embodiments of the invention, together with advantages and features, by way of example with reference to the drawings.

### DETAILED DESCRIPTION OF THE INVENTION

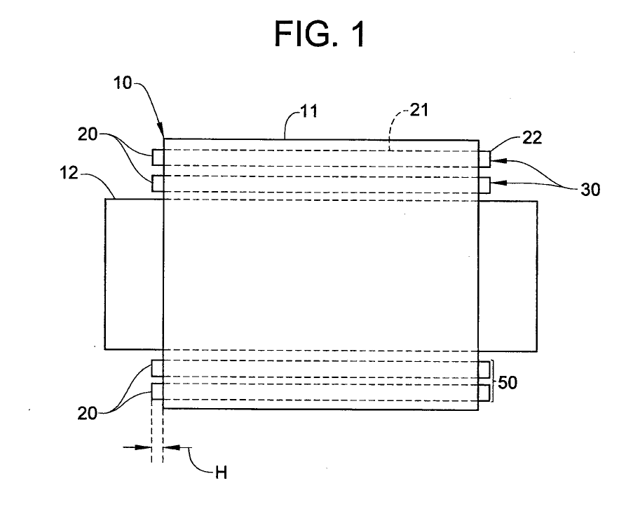

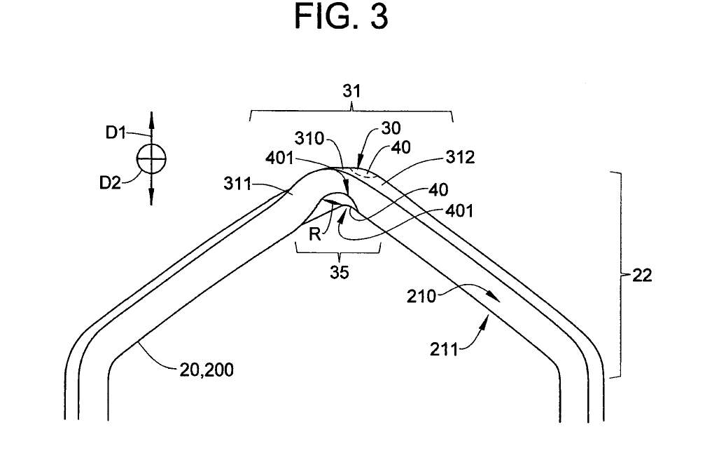

With reference to FIGS. 1-4, an electro-dynamic machine 10 includes a stator 11, a rotor 12 and a plurality of conductive elements 20. The stator 11 may be annular in shape and is formed to define an aperture 111 in which the rotor 12 is rotatably disposable. The plurality of conductive elements 20 is supportively disposed in the stator 11 and receptive of current to thereby drive rotation of the rotor 12. Each one of the plurality of conductive elements 20 includes an electrically conductive material 201 and a coating 202 surrounding the electrically conductive material 201 (see FIG. 4). As shown in FIG. 3, each one of the plurality of conductive elements 20 is formed with a crown 30 defined by bends 31 in first and second transverse dimensions D1 and D2 (see FIG. 3). For each one of the plurality of conductive elements 20, the electrically conductive material 201 is formed to define at least one divot 40 (see FIG. 3), which is discernible through the coating 202. The at least one divot 40 is proximate to the crown 30.

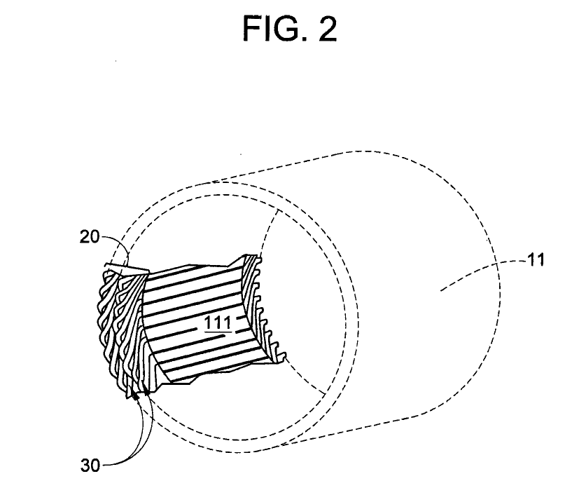

As shown in FIG. 1, each one of the plurality of conductive elements 20 may be provided as a high voltage hairpin (HVH) style conductor and includes elongate legs 21 and a hairpin portion 22 interposed between the elongate legs 21. The crowns 30 are formed at the hairpin portions 22. The elongate legs 21 may be secured in the stator 11 such that, as shown in FIG. 2, the plurality of conductive elements 20 is arranged in a two-deep circumferential array 50 with the crowns 30 disposed at one axial side of the stator 11. With such a configuration and, in accordance with exemplary embodiments, each one of the divots 40 may have a radius R (see FIG. 3) of about 0.5 mm such that each one of the plurality of conductive elements 20 may have about 1 mm of clearance from an adjacent one of the plurality of conductive elements 20. This then permits an arrangement of the plurality of conductive elements 20 that is relatively tight. Therefore, a height H or thickness of the respective hairpin portions 22 of the plurality of conductive elements 20 as measured from a plane of the corresponding axial end of the stator 11 may be relatively reduced.

As shown in FIG. 4, the electrically conductive material 201 may have a rectangular or square cross-section with possibly rounded or otherwise smooth corners and, in some cases, dimensions of about 3×4 mm. An interior surface of the coating 202 may be adjacent to the electrically conductive material 201 such that a cross-sectional shape of the coating 202 may be substantially similar to that of the electrically conductive material 201. The coating 202 may be about 0.2 mm thick. In the exemplary case of FIG. 4, the electrically conductive material 201 has a rectangular cross-section and the coating 202 has a similarly rectangular cross-section with possibly rounded or otherwise smooth corners.

As shown in FIG. 3, for each one of the plurality of conductive elements 20, the bends 31 of the crown 30 include a first bend 310, a second bend 311 and a third bend 312. The first bend 310 is formed in the first dimension D1, which runs top-down along the plane of the illustration and longitudinally through the stator 11. The second and third bends 311 and 312 are formed in the second dimension D2, which runs into and out of the plane of the illustration and radially relative to the annularity of the stator 11. The bending direction of the third bend 312 is opposite that of the second bend 311. Thus, the crown 30 includes a kink 35 formed by the second and third bends 311 and 312. This kink 35 extends across the length of the first bend 310.

The at least one divot 40 may be defined at an underside of the crown 30 and/or at an outer-side of the crown 30. That is, the divot 40 may be defined on an interior side of the first bend 310 and on an exterior side of the third bend 312 and may be positioned at an end portion of the kink 35 in the crown 30. Additionally or alternatively, the divot 40 may be defined on an exterior side of the first bend 310 and on an interior side of the third bend 312.

The divot 40 may include an indentation, impression or depression of the coating 202, which is encompassed by an edge 401. The edge 401 defines a border of the divot 40 and extends along first and second sides 210 and 211 of the corresponding conductive element 20. The first and second sides 210 and 211 are adjacent to one another. That is, with the divot 40 defined on an interior side of the first bend 310 and on an exterior side of the third bend 312 and positioned at an end portion of the kink 35 in the crown 30, the edge 401 traverses several bent structural elements. For example, the edge 401 traverses the exterior side of the third bend 312 and the edge defined between the first and second sides 210 and 211. The edge 401 further traverses an interior portion of the third bend 312 in compression and re-traverses the edge defined between the first and second sides 210 and 211.

With the at least one divot 40 disposed on at least the interior of the crown 30 as described above for each one of the plurality of conductive elements 20, each of the at least one divots 40 allows improved nesting of the plurality of conductive elements 20 that in turn leads to an improved form factor of the stator assembly, which includes the stator 11 and the plurality of the conductive elements 20. That is, the divots 40 allow each one of the plurality of conductive elements 20 to be located closer together while still maintaining necessary and, in some cases, uniform clearances between adjacent ones of the plurality of conductive elements 20.

Each one of the plurality of conductive elements 20 may be formed as follows. Initially, the electrically conductive material 201 is provided with the possibly rectangular cross-section and coated with the coating 202 to form a coated member 200. At the location of the crown 30, the coated member 200 is bent between, for example, two or more dies to form the first bend 310 in the first dimension D1. Simultaneously or subsequently, the coated member 200 is bent between additional dies to form the second and third bends 311 and 312 in the second dimension D2. In accordance with embodiments, the divot 40 may be defined during the bending of the coated member 200. In particular, the divot 40 may be defined during the formation of the first bend 310 in the first dimension D1. In accordance with further embodiments, the definition of the divot 40 may be achieved by pressurizing a rounded element, such as a steel ball, into the electrically conductive material 201 at the desired location of the divot 40 such that the divot 40 is discernible through the coating 202.

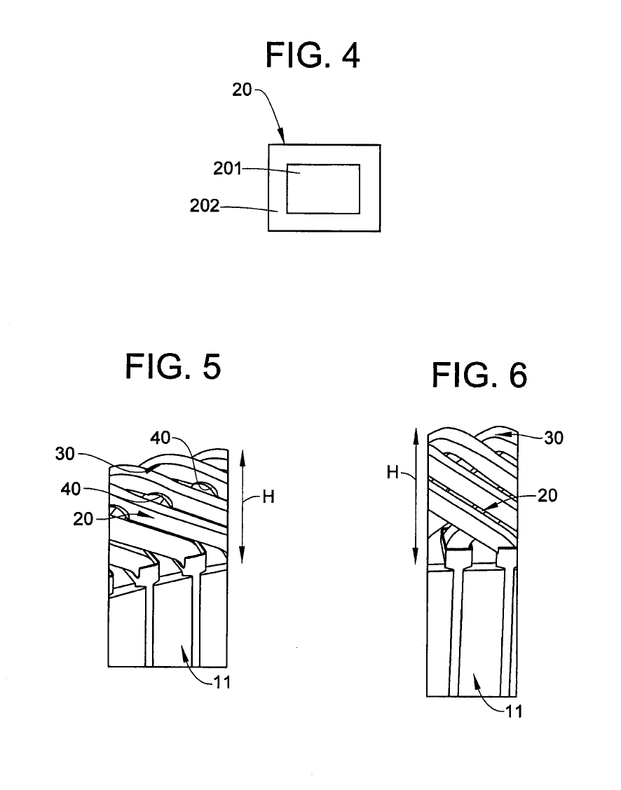

With reference to FIGS. 5 and 6, arrangements of the stator 11 and the plurality of conductive elements 20 of the electro-dynamic machine 10 are illustrated in accordance with embodiments. As shown in FIG. 5, the location of the divots 40 proximate to the respective crown ends 30 for each one of the plurality of conductive elements 20 permits improved nesting of the plurality of conductive elements 20 and a relatively tight formation thereof. In this case, a required clearance of, for example, 1.0 mm, between adjacent ones of the plurality of conductive elements 20 is possible even with the otherwise relatively tight formation. By contrast, as shown in FIG. 6, the absence of divots in the corresponding conductive elements requires that the formation of the conductive elements be relatively loose if the required clearances are to me maintained. Therefore, the height H of the respective hairpin portions 22 of the plurality of conductive elements 20 as measured from a plane of the corresponding axial end of the stator 11 is reduced in the configuration illustrated in FIG. 5 as compared to that of FIG. 6.

Although it is not shown in FIG. 5, it is to be understood that the improved nesting of the plurality of the conductive elements 20 may be further improved by defining divots 40 on both the interior and exterior of the crowns 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A conductive element, comprising:
an electrically conductive material; and
a coating surrounding the electrically conductive material to form a coated member,
the coated member being formed with a crown defined by bends in first and second transverse dimensions, and
the electrically conductive material being formed to define at least one divot proximate to the crown, the at least one divot being discernible through the coating.

2. The conductive element according to claim 1, wherein the conductive element comprises a high voltage hairpin (HVH) style conductor.

3. The conductive element according to claim 1, wherein the at least one divot has a radius of about 0.5 mm.

4. The conductive element according to claim 1, wherein the bends of the crown include a first bend in the first dimension and second and third opposite bends in the third dimension.

5. The conductive element according to claim 1, wherein the at least one divot is defined at an underside of the crown.

6. The conductive element according to claim 1, wherein the at least one divot is defined at an outer-side of the crown.

7. The conductive element according to claim 1, the electrically conductive material is formed to define:
a divot proximate to the crown at an underside of the crown, and
a divot proximate to the crown at an outer-side of the crown.

8. An electro-dynamic machine, comprising:
a stator;
a rotor rotatably disposed in the stator; and
a plurality of conductive elements supportively disposed in the stator and receptive of current to drive rotation of the rotor,
each one of the plurality of conductive elements comprising:
an electrically conductive material; and
a coating surrounding the electrically conductive material and being formed with a crown defined by bends in first and second transverse dimensions,
the electrically conductive material being formed to define at least one divot proximate to the crown, the at least one divot being discernible through the coating.

9. The electro-dynamic machine according to claim 8, wherein the plurality of conductive elements is arranged in a two-deep circumferential array with the crowns disposed at one axial side of the stator.

10. The electro-dynamic machine according to claim 8, wherein each one of the plurality of conductive elements has about 1 mm of clearance from an adjacent one of the plurality of conductive elements.

11. The electro-dynamic machine according to claim 8, wherein each one of the plurality of conductive elements comprises a high voltage hairpin (HVH) style conductor.

12. The electro-dynamic machine according to claim 8, wherein each of the at least one divots has a radius of about 0.5 mm.

13. The electro-dynamic machine according to claim 8, wherein the bends of each of the crowns include a first bend in the first dimension and second and third opposite bends in the third dimension.

14. The electro-dynamic machine according to claim 8, wherein each of the at least one divots is defined at an interior of the crown.

15. The electro-dynamic machine according to claim 8, wherein each of the at least one divots is defined at an exterior of the crown.

16. The electro-dynamic machine according to claim 8, wherein the electrically conductive material is formed to define:
a divot proximate to the crown at an underside of the crown, and
a divot proximate to the crown at an outer-side of the crown.

17. A method of fashioning a conductive element, comprising:
surrounding an electrically conductive material with a coating to form a coated member;
bending the coated member in first and second transverse dimensions to provide the coated member with a crown; and
defining at least one divot in the electrically conductive material proximate to the crown during the bending such that the at least one divot is discernible through the coating.

18. The method according to claim 17, wherein the bending comprises:
bending the coated member once in the first dimension to form a first bend; and
bending the coated member twice in opposite directions in the second dimension to form second and third bends, respectively.

19. The method according to claim 18, wherein the defining of the at least one divot is conducted during the bending of the coated member in the first dimension.

20. The method according to claim 18, wherein the defining comprises defining the at least one divot on one or both of an underside and an outer-side of the crown.
